(19) United States
(12) Patent Application Publication
(10) Pub. No.: US 2001/0006547 A1
(43) Pub. Date: Jul. 5, 2001

(54) Methods and systems for connecting a call processing system to a telephone network using an SS7 gateway

(76) Inventors: David W. Chung, San Pedro, CA (US); Sae Joon Kim, Pico Rivera, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/752,412

(22) Filed: Dec. 28, 2000

(30) Foreign Application Priority Data
Dec. 29, 1999 (KR) F19C019
Dec. 29, 1999 (KR) F19C020/US

(51) Int. Cl. H04M 3/42; H04M 7/00

(52) U.S. Cl. 379/207.02; 379/88.18; 379/229

(57) ABSTRACT

Methods and apparatus are provided in which a circuit board is mounted in a leader board via retaining elements that are coupled to a base, and wherein one or more support elements further support the circuit board.

### FIELD OF THE INVENTION

The field of the invention is retaining devices for processing circuit boards.

### BACKGROUND OF THE INVENTION

High throughput equipment has been developed to guide electronic circuitry and devices through various processing steps. Due to the relatively sensitive nature of many integrated circuitries and electronic devices, carrier mechanisms have been developed that secure the electronic devices without inflicting undesirable levels of mechanical stress.

For example, an electrical device or circuit board may be inserted into a tape as described in U.S. Pat. No. 5,769,237 (Jun. 23, 1998) to Althouse et al, U.S. Pat. No. 4,966,282 (Oct. 30, 1990) to Kawanishi et al., U.S. Pat. No. 5,524,765 (Jun. 11, 1996) to Gutentag, or U.S. Pat. No. 5,648,136 (Jul. 15, 1997) to Bird. Inserting circuit boards or other electronic devices into corresponding cavities in tapes typically allows fast processing and transport. also, the bottom portion of such cavities advantageously provides a support structure that helps prevent deformation of the circuit board or electronic device. However, insertion of circuit boards or electronic devices is generally problematic where both sides (i.e., the top side and the bottom side) of the boards or devices need to be accessed, which often necessitate removal and reinsertion of the boards or devices into the tape.

To circumvent at least some of the problems attending limited access to both sides, the circuit board or electronic device may be attached to an adhesive tape, such that one portion of the tape is attached to at least one side of the board or device, and another portion of the tape engages with the actuation mechanism of the high throughput equipment. Taping a circuit board or electronic device generally allows at least partial access to both sides of the board or device. However, attaching the board or device to a tape frequently reduces mechanical support of the board or device. Furthermore, a relatively large area on the board or device is often required to securely attach the board or device to the tape, thereby frequently rendering functionally relevant areas on the board or device inaccessible.

Although various methods and apparatus for retaining circuit boards during processing are known in the art, all or almost all of them suffer from one or more disadvantage. Therefore, there is still a need to provide improved methods and apparatus for retaining circuit boards during processing.

### SUMMARY OF THE INVENTION

The present invention is directed to methods and apparatus for retaining circuit boards, in which a leader board has a base that is configured to cooperate with an actuating mechanism in a conveyor system. A plurality of retaining elements are coupled to the base and are configured to at least temporarily retain the circuit board, which is further supported by one or more support element that are coupled to the base and located between the retaining elements.

In one aspect of the inventive subject matter the base comprises a top and a bottom element, and in especially contemplated leader boards the top element comprises a lever, the bottom element comprises a cutout that forms a fulcrum, and the lever, the cutout, and a finger form the retaining element. Top and a bottom elements are preferably fabricated from FR-4.

In another aspect of the inventive subject matter, an additional layer (preferably a prepreg) is disposed between the top and bottom elements, and it is further contemplated that the finger of the retaining element comprises a metal point. Contemplated circuit boards particularly include printed wiring boards and printed circuit boards.

In a further aspect of the inventive subject matter, a leader board is movably coupled to at least another leader board, and it is particularly preferred that the movably coupled leader boards can be stored in form of or on a roll.

Various objects, features, aspects and advantages of the present invention will become more apparent from the following detailed description of preferred embodiments of the invention, along with the accompanying drawing.

### BRIEF DESCRIPTION OF THE DRAWING

FIG. 1 is a top view of an exemplary leader board.

FIGS. 2A and 2B are top views of top and bottom elements of the leader board of FIG. 1, respectively.

FIG. 3 is a vertical cross sectional view of an exemplary leader board.

FIG. 4 is a top view of an exemplary leader board coupled to another exemplary leader board.

FIG. 5 is a perspective view of a plurality of exemplary leader boards on a roll.

### DETAILED DESCRIPTION

A leader board generally has a base configured to cooperate with an actuating mechanism in a conveyor system, a plurality of retaining elements coupled to the base and configured to at least temporarily retain a circuit board, and a support element coupled to the base and located between the plurality of retaining elements.

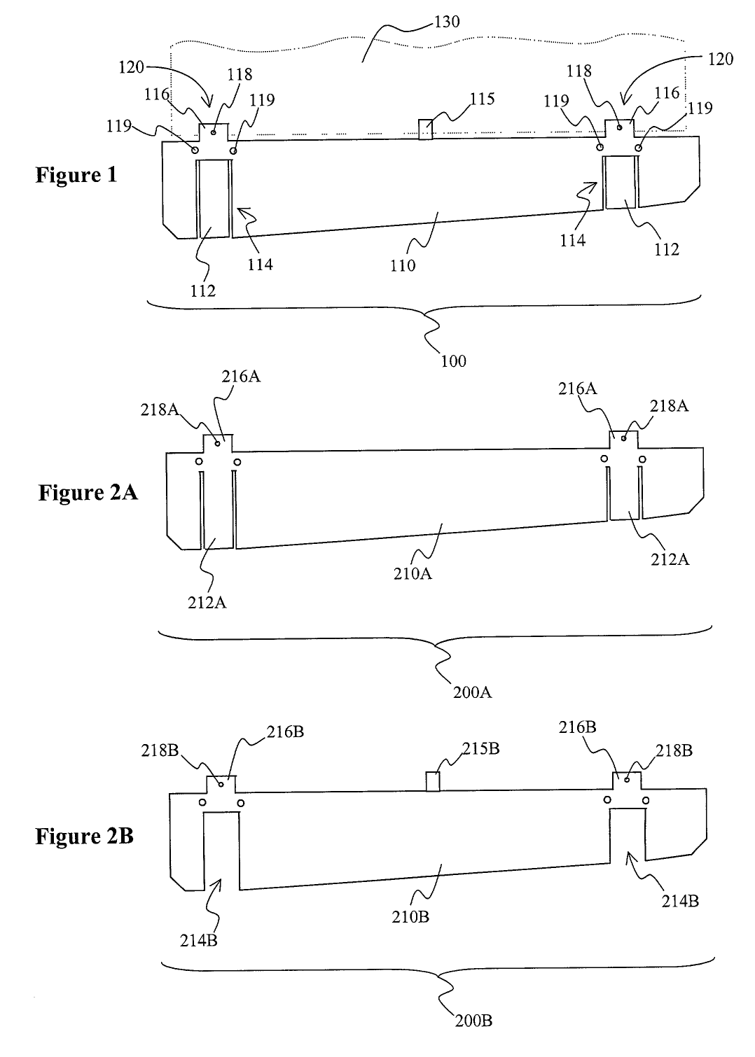

In a particularly contemplated configuration as depicted in FIG. 1, a leader board 100 has a base 110 with a top element and a bottom element (not shown, see FIGS. 2A-2B). A lever 112 in proximal position to cutout 114, and finger 116 form a retaining element 120. The finger 116 further comprises a metal point 118, and press fit connectors 119 couple the top element to the bottom element. Support element 115 is coupled to the bottom element. An electronic device (e.g., a circuit board or printed wiring board; hatched lines, only partially shown) 130 is retained in the leader board 100. FIG. 2A depicts top element 200A comprising base 210A with levers 212A and fingers 216A, which further include metal points 218A. FIG. 2B depicts bottom element 200B comprising base 210B with cutouts 214B and fingers 216B, which also include metal points 218B. Support element 215B is coupled to the base.

With respect to the dimensions of the leader board, it should be recognized that particular dimensions will typically depend on the size of the circuit board that is to be retained. Consequently, it is contemplated that suitable leader boards need not be limited to a particular length, width, and thickness. However, it is preferred that appropriate leader boards have an overall length of between about 0.2 inches and 20 inches. Similarly, it is preferred that contemplated leader boards have a width of approximately 0.2 inches to 5 inches. With respect to the thickness, it is generally contemplated that a particularly suitable thickness will be in the range of about 0.02 inches to about 1.0 inch.

While it is particularly preferred that contemplated leader boards are fabricated from commercially available FR-4, various alternative materials are also contemplated and especially include low dielectric constant materials with a dielectric constant of less than 10, and more preferably less than 5. Further especially contemplated alternative materials include materials with a coefficient of thermal expansion (CTE) that is in a substantially similar range (i.e., difference in CTE no more than 20%, preferably no more than 10%, and more preferably no more than 5%) than the circuit board that is to be retained. Consequently, particularly preferred alternative materials include organic and inorganic polymers, organic and inorganic polymer composite materials, metals, and any reasonable combination thereof.

With respect to the shape of contemplated leader boards, it should be appreciated that a particular shape will generally depend on the shape of the circuit board to be held and on the configuration of the particular actuation mechanism that contacts the base. Therefore, the shape of contemplated leader boards need not be limited to the exemplary shape as depicted in FIG. 1, but may have numerous alternative shapes, so long as alternative leader boards have at least two retaining elements, at least one supporting element located between the at least two retaining elements, and a base that is configured to cooperate with an actuating mechanism in a conveyor system. For example, where the circuit board has a curved or otherwise non-linear portion (i.e., a portion that is not straight), suitable leader boards may include a correspondingly curved or otherwise non-linear portion at the side where the circuit board engages with the leader board. In another example, it is contemplated that the base may include indentations, perforations, or other structural feature that interlocks or other contacts an actuator mechanism in the conveyor system. Alternatively, additional structures or labels may be disposed on the base or other portion of the leader board that identify or mark the position of the leader board relative to the conveyor system.

In still further alternative aspects of the inventive subject matter, it is especially preferred that the leader board comprises a top element and a bottom element, wherein both elements are fabricated from the same material and wherein both elements are coupled together via a set of press fit connectors. Exemplary top and bottom elements are depicted in FIG. 2 (supra). However, it should be appreciated that suitable leader boards may be fabricated from more than two elements or from a single piece of material. For example, where additional functional components (e.g., retaining elements, supporting elements, etc.) on the leader board are desirable, such components may be added to the leader board via an additional element. On the other hand, where assembly of top and bottom elements is undesirable (e.g., to reduce cost or manufacturing time), suitable leader boards may be fabricated from a single piece of material (e.g., via routing, pressing, extruding, molding, etc.). It is further contemplated that the coupling of the top and bottom element may vary substantially, and appropriate couplings may include temporary and permanent coupling (e.g., gluing, bolting, sliding, snapping, soldering, etc.), or no coupling at all where the leader board is fabricated from a single piece of material.

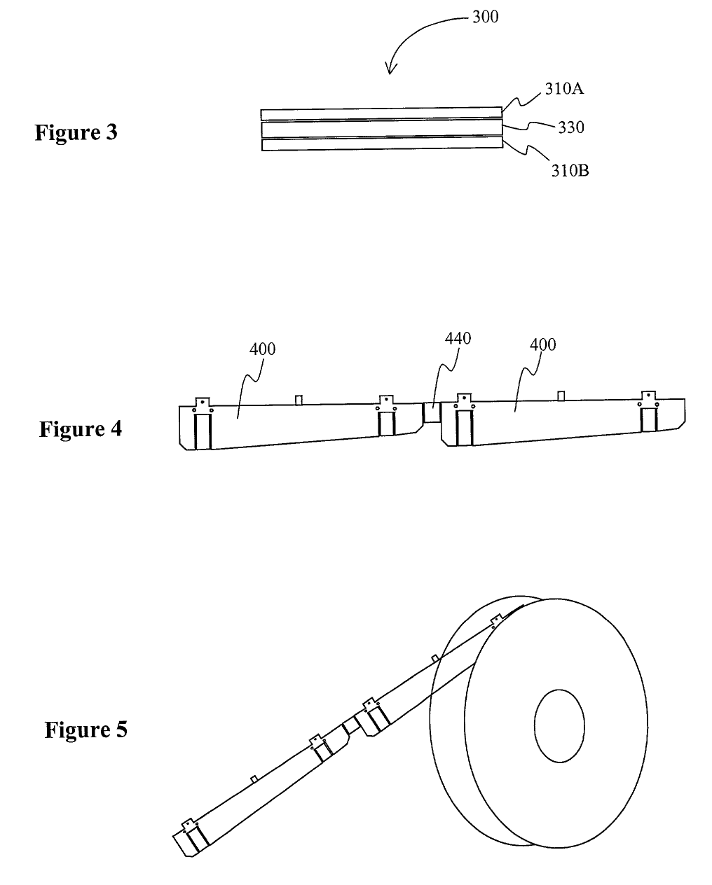

It should further be appreciated that contemplated leader boards may comprise additional material, and it is especially preferred that a layer of prepreg is included in the leader board between the top and bottom layer as depicted in FIG. 3 (leader board 300 has a top element 310A and a bottom element 310B, which at least partially enclose prepreg 330). Where prepreg is installed between the top and bottom layer, it is further preferred that the leader board undergoes a lamination cycle.

With respect to the retaining element it is preferred that it is formed by a cutout and a finger on the bottom element together with a lever and a finger on the top element, in which part of the cutout forms a fulcrum, and in which the inherent elasticity of the material of the top and bottom element provides the force that keeps the fingers in a retaining position. Pressure on the lever that forces the lever to move into the cutout forces the fingers apart, while removing pressure from the lever results in moving of the finger together. The size and form of suitable fingers may vary substantially, however, it is preferred that the finger is sized and shaped to minimize the area in which the finger contacts the circuit board. Thus, preferred fingers have a contact area with the circuit board of no more than 10% of the surface of the circuit board, preferably no more than 5% of the surface of the circuit board, more preferably no more than 3% of the surface of the circuit board, and most preferably no more than 1% of the surface of the circuit board. Suitable fingers may further include components that physically interact with the circuit board that is to be retained, and especially suitable components include metal points (e.g., 316 SS Points), hooks and loops.

In alternative aspects of the inventive subject matter, various retaining elements other the preferred retaining element depicted in FIG. 1 are also contemplated, and suitable retaining elements include fingers attached to the base or other portion of the leader board, wherein the fingers embrace at least part of the top and bottom portion of a circuit board that is top be retained. Further alternative retaining element include elements that reversibly or irreversibly attach to the circuit board to be retained, so long as such elements are not a tape.

It should be particularly appreciated that suitable retaining elements contact the circuit board that is to be retained in a discontinuous fashion (i.e., contact only a portion of one side of a circuit board). Consequently, the amount of blocked or otherwise inaccessible areas is significantly reduced when retaining circuit boards with contemplated leader boards. While prior art devices employ tapes along at least one side of a circuit board and therefore block the taped side of the circuit board from contact with process fluids (e.g., resist stripper), the leader board according to the inventive subject matter allows substantially increased contact of process fluids with the retained circuit board. It should further be appreciated that the number of contemplated retaining elements may vary substantially, and it is contemplated that suitable leader boards may include three to ten, and more retaining elements. Depending on the number of the retaining elements, it is contemplated that the positioning of the retaining elements need not be limited to the positioning as depicted in FIG. 1. Suitable positioning may include evenly spaced positioning along at least one side of the base, positioning that concentrates two or more retaining elements towards a particular location, and random positioning. For example, where relatively large circuit boards are retained, evenly spaced retaining elements are particularly preferred.

With respect to the support elements, it is contemplated that in preferred configurations of the leader board the support element is coupled to the bottom element of the leader board and that the support element is disposed between two retaining elements. It is further preferred that contemplated support elements are fabricated from the same material as the bottom element, and that the support element is an integral part of the leader board. With respect to the size and number of contemplated support elements the same consideration as for the finger apply (supra). It should further be appreciated that additional support elements may be disposed on the top element, and that where more than one support element is employed, the support elements may be in a juxtaposed or distal position relative to each other.

In still further contemplated aspects of the inventive subject matter, a leader board may be coupled to at least a second leader board as shown in FIG. 4, in which two leader boards 400 are movably coupled via a coupling element 440. Coupling element 440 is preferably fabricated from the same material as the leader boards, and movability is preferably imparted by partial or complete perforation or thinning of the joint that connects the leader board to the coupling element. It is particularly contemplated that multiple leader boards may be configured in form of a roll or stored rolled up onto a roll as depicted in FIG. 5.

Consequently, a method of retaining a circuit board has one step in which a leader board is provided, wherein the leader board has a base configured to cooperate with an actuating mechanism in a conveyor system, a plurality of retaining elements coupled to the base and configured to at least temporarily retain the circuit board, and a support element coupled to the base and located between the plurality of retaining elements. In a further step, the circuit board is inserted into at least some of the plurality of retaining elements such that the circuit board is further supported by the support element. With respect to the leader board and its components, the same considerations as described above apply.

Thus, specific embodiments and applications for leader boards have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A leader board comprising:
a base configured to cooperate with an actuating mechanism in a conveyor system;
a plurality of retaining elements coupled to the base and configured to at least temporarily retain a circuit board; and
a support element coupled to the base and located between at least two of the plurality of retaining elements.

2. The leader board of claim 1 wherein the base comprises a top element and a bottom element.

3. The leader board of claim 2 wherein the top element comprises a lever and the bottom element comprises a fulcrum for the lever.

4. The leader board of claim 3 wherein the bottom element comprises a cutout that at least partially defines the fulcrum.

5. The leader board of claim 2 wherein at least one of the top element and the bottom element comprises an FR-4 glass epoxy layer.

6. The leader board of claim 4 wherein at least one of the retaining element is formed at least in part by the lever and the cutout, and wherein the retaining element further comprises a finger coupled to at least one of the top and bottom elements.

7. The leader board of claim 6 wherein the finger further comprises a metal point.

8. The leader board of claim 2 further comprising a separating layer between the top element and the bottom element.

9. The leader board of claim 8 wherein the separating layer comprises a prepreg.

10. A chain comprising a plurality of leader boards according to claim 1, wherein at least two of the plurality of leader boards are movably coupled to each other.

11. The chain of claim 10 wherein at least part of the plurality of leader boards are configured in a roll.

12. A leader board system comprising a leader board according to claim 1, wherein the leader board is further coupled to at least one of a printed wiring board and a printed circuit board.

13. A method of retaining a circuit board, comprising:
providing a leader board comprising a base configured to cooperate with an actuating mechanism in a conveyor system, a plurality of retaining elements coupled to the base and configured to at least temporarily retain the circuit board, and a support element coupled to the base and located between the plurality of retaining elements; and
inserting the circuit board into at least some of the plurality of retaining elements such that the circuit board further contacts the support element.

14. The method of claim 13 wherein the base comprises a top element and a bottom element, and wherein the top element comprises a lever and the bottom element comprises a fulcrum for the lever.

15. The method of claim 14 wherein the bottom element further has a cutout that at least partially defines the fulcrum.

16. The method of claim 13 further comprising providing a second leader board and inserting the circuit board into at least some of the plurality of retaining elements of the second leader board such that the circuit board further contacts the support element of the second leader board.
